(19) United States
(12) Patent Application Publication
(10) Pub. No.: US 2007/0028881 A1
(43) Pub. Date: Feb. 8, 2007

(54) Supplementary fuel supply for a carbureted engine

(75) Inventors: Hiroshi Nakata, Shibata-Gun (JP); Makoto Waku, Kurokawa-Gun (JP)

Correspondence Address: Mr. William H. Francis;Reising, Ethington, Barnes, Kisselle, P.C., P.O. Box 4390, Troy, MI, 48099-4390, US

(73) Assignee: Walbro Engine Management, L.L.C.

(21) Appl. No.: 11/580,558

(22) Filed: Oct. 13, 2006

Related U.S. Application Data
(63) Continuation-in-part of application No. 11/274,086, filed on Nov. 15, 2005.

(30) Foreign Application Priority Data
Nov. 18, 2004 (JP) 2004-334842
Oct. 14, 2005 (JP) 2005-299572
Oct. 19, 2005 (JP) 2005-304095
Nov. 25, 2005 (JP) 2005-340049

(51) Int. Cl. F02M 1/12

(52) U.S. Cl. 123/179.15

(57) ABSTRACT

A method includes controlling supply of supplementary fuel through a supplementary fuel supply passage in a carburetor to an engine. Engine cranking is sensed, and the supply of the supplementary fuel is prevented when the engine cranking reaches a prescribed number of revolutions. Accordingly, an excessive amount of fuel is not supplied to the engine when the engine fails to start, so that flooding of an engine spark plug can be avoided and the possibility of successfully starting the engine by subsequent engine cranking is increased.

### CROSS-REFERENCE TO RELATED APPLICATIONS

This application is a continuation-in-part of copending U.S. patent application Ser. No. 11/274,086, filed Nov. 15, 2005, which claimed priority of Japanese Application, Ser. No. 2004-334842, filed Nov. 18, 2004, and Japanese Application, Ser. No. 2005-299572, filed Oct. 14, 2005.

Applicants claim priority of Japanese Application 2004-334842, filed Nov. 18, 2004; Japanese Application, Ser. No. 2005-299572, filed Oct. 14, 2005; Japanese Application, Ser. No. 2005-304095, filed Oct. 19, 2005; and Japanese Application, Ser. No. 2005-340049, filed Nov. 25, 2005.

### FIELD OF THE INVENTION

The present invention relates generally to fuel delivery in internal combustion engines, and more particularly to supplementary fuel supply for a carbureted engine.

### BACKGROUND OF THE INVENTION

A carburetor of an internal combustion engine is known to have a fuel-and-air mixing passage for delivering a controlled ratio of fuel-and-air to a combustion chamber of the engine. The fuel-and-air mixing passage is carried by a body of the carburetor and has a choke valve disposed therein to generally control or limit an amount of air flowing through the mixing passage. Liquid hydrocarbon fuel flows from a fuel chamber of the carburetor, through a primary fuel supply passage in the carburetor body, and into the mixing passage.

The typical fuel-to-air ratio of a hot, running engine is generally less than the fuel-to-air ratio necessary to reliably start a cold engine. To adjust the fuel-to-air ratio, the choke valve is typically used to limit the air flow rate through the mixing passage relative to the fuel flow rate. For example, prior to starting a cold engine an operator manually places the choke valve in a substantially closed or “choke-on” position. Accordingly, the choke valve blocks or “chokes” air flow through the fuel-and-air mixing passage to such an extent that pulsating vacuum induced by reciprocating pistons in the engine will be higher than normal in the mixing passage and, thus, will pull an extra quantity of fuel from the fuel chamber into the mixing passage and the combustion chamber. Accordingly, a fuel-rich mixture of fuel-and-air flows through the mixing passage and into the combustion chamber of the engine.

In addition, some carburetors are known to have startup systems for a carburetor that provide an additional amount of fuel when cranking a cold engine by opening a “start fuel” or supplementary fuel supply passage provided separately from the primary fuel supply passage, and that stop the supply of the start fuel once the engine has been successfully started. In some cases, however, the engine may fail to start quickly and, because the supplementary fuel supply passage remains open, the start fuel continues to be supplied to the engine, thereby “flooding” a spark plug in the combustion chamber of the engine with an excessively rich mixture of fuel-and-air. Once the spark plug becomes flooded, the engine is difficult or impossible to start, and the operator must wait until the fuel evaporates from the spark plug before trying to start the engine again.

In a specific example, according to Japanese Utility Model Application No. 1-96630, a system includes a thermistor for detecting the temperature of an engine as well as a sensor for detecting a rotational speed of the engine, and a reference value of the engine speed is defined in relation to the detected engine temperature. Accordingly, an added amount of start fuel is supplied to the engine by opening a supplementary fuel supply passage when the engine speed at engine start up is below the reference value, and the added amount of start fuel is not supplied to the engine by closing the supplementary fuel supply passage when the engine speed is above the reference value. In other words, engine start up fuel is controlled according to the engine speed and temperature. With this system, however, if the engine fails to quickly start, the engine remains cold and the start fuel continues to be supplied, thereby flooding the engine spark plug and rendering the engine very difficult to start without a significant delay.

In addition to the issues described above, a hot running two-stroke engine can be cooled by fueling the engine with a fuel-to-air ratio somewhat richer than a combustion stoichiometric ratio. However, recent emission control regulations require a leaner combustion of fuel, and the supply of fuel is usually reduced so as to achieve a mixture having a ratio closer to the stoichiometric ratio to reduce hydrocarbon and carbon monoxide in exhaust gas.

But because the reduced supply of fuel reduces the cooling effect, the combustion temperature and the temperature of the engine may rise to such an extent that the fuel may be excessively heated before ignited. In particular, the excessive heating of the fuel can create hot spots in the engine that combine with a rapid rise in compression pressure to prematurely ignite the fuel. Under such “self-ignition” conditions, the rotational speed of the engine may increase so rapidly without regard to normal ignition control that the engine could become damaged. Accordingly, ignition timing can be controlled to prevent such self-ignition, but this can be a complex and costly solution.

### SUMMARY OF THE INVENTION

According to one form of the invention, a method includes controlling supply of supplementary fuel through a supplementary fuel supply passage in a carburetor to an engine. In this method, engine cranking is sensed, and the supplementary fuel is prevented from being supplied when the engine cranking reaches a prescribed amount. Accordingly, an excessive amount of fuel is not supplied to the engine when the engine fails to start, so that flooding of an engine spark plug can be avoided and the possibility of successfully starting the engine by subsequent engine cranking is increased. According to one preferred aspect of this form of the invention, a heater element is powered during cranking and a thermistor is placed adjacent the heater element to sense engine cranking via the heater element. According to another preferred aspect of this form of the invention, engine cranking is sensed by counting engine revolutions.

According to another form of the invention, the method includes sensing engine cranking using a rotation sensor to sense engine rotation, and a rotation counter to count engine revolutions, and preventing supply of the supplementary fuel when the counted engine revolutions exceeds a prescribed number of engine revolutions. Accordingly, an excessive amount of fuel is not supplied to the engine when the engine fails to start, so that flooding of an engine spark plug can be avoided and the possibility of successfully starting the engine by subsequent engine cranking is increased. According to a preferred aspect of this form of the invention, the prescribed number of engine revolutions varies depending on engine temperature.

According to a further form of the invention, the method includes sensing engine speed, preventing supply of the supplementary fuel when the sensed engine speed is below a prescribed normal operating speed, and permitting supply of the supplementary fuel when the sensed engine speed exceeds the prescribed normal operating speed. Accordingly, fuel is supplied to the engine for cooling when the engine speed becomes excessive, so that hot spots and self-ignition can be prevented and concomitant engine overspeed and damage can be avoided. According to a preferred aspect of this form of the invention, a generator coil is used to power a solenoid valve to permit and prevent the fuel supply, and the permitting and preventing steps are carried out in synchronism with engine intake negative pressure.

At least some of the objects, features and advantages that may be achieved by at least certain embodiments of the invention include providing a method and system that supplies supplementary fuel to an engine by automatically initiating supplementary fuel supply during engine startup and automatically ceasing supplementary fuel supply after the engine has successfully started, avoids an excessively rich fuel-to-air mixture and concomitant engine flooding during startup, provides engine control circuitry that also serves as ignition control circuitry, integrates control circuitry, a resistive heater element, and a thermistor into a module, provides cooling of a hot running engine, minimizes generation of engine hot spots and fuel self-ignition, is of relatively simple design and economical manufacture and assembly, durable, reliable and in service has a long useful life.

Of course, other objects, features and advantages will be apparent in view of this disclosure to those skilled in the art. Other methods and systems embodying the invention may achieve more or less than the noted objects, features or advantages.

### BRIEF DESCRIPTION OF THE DRAWINGS

These and other objects, features and advantages of the present invention will be apparent from the following detailed description of the preferred embodiment and best mode, appended claims, and accompanying drawings in which:

FIG. 1 is a schematic diagram of an exemplary form of an automatic supplementary fuel supply system for use with an internal combustion engine including a carburetor;

FIG. 2 is a schematic diagram of an exemplary control circuit of the system of FIG. 1;

FIG. 3 is a flowchart showing an exemplary method of operating a supplementary fuel supply system;

FIG. 4 is a schematic diagram of another exemplary form of an automatic supplementary fuel supply system;

FIG. 5 is a schematic diagram of an exemplary control circuit of the system of FIG. 4;

FIG. 6 is a schematic diagram of another exemplary control circuit of the system of FIG. 4;

FIG. 7 is a schematic diagram of a modification of the exemplary control circuit of FIG. 6;

FIG. 8 is a schematic diagram of an exemplary form of an internal combustion engine and related apparatus;

FIG. 9 is a schematic diagram of another exemplary form of a supplementary fuel supply system;

FIG. 10 is an exemplary control circuit of the system of FIG. 9;

FIG. 11 is an exemplary timing diagram for the control circuit of FIG. 10;

FIG. 12 is an exemplary control map for the control circuit of FIG. 10;

FIG. 13 is a schematic diagram of another exemplary form of an internal combustion engine and related apparatus;

FIG. 14 is a schematic diagram illustrating a magneto device of the internal combustion engine and apparatus of FIG. 13;

FIG. 15 is a block diagram of a control circuit for the engine and apparatus of FIG. 13;

FIG. 16a is a schematic diagram of the engine of FIG. 14, illustrating a first timing position of the magneto device;

FIG. 16b is a graph illustrating a waveform, wherein a solid portion of the waveform corresponds to the first timing position of FIG. 16a;

FIG. 17a is a schematic diagram of the engine of FIG. 14, illustrating a second timing position of the magneto device;

FIG. 17b is a graph illustrating the waveform of FIG. 16b, wherein a solid portion of the waveform corresponds to the second timing position of FIG. 17a;

FIG. 18a is a schematic diagram of the engine of FIG. 14, illustrating a third timing position of the magneto device;

FIG. 18b is a graph illustrating the waveform of FIG. 16b, wherein a solid portion of the waveform corresponds to the third timing position of FIG. 18a; and

FIG. 19 is a timing diagram illustrating a solenoid valve opening and closing.

### DETAILED DESCRIPTION OF THE PREFERRED EMBODIMENT

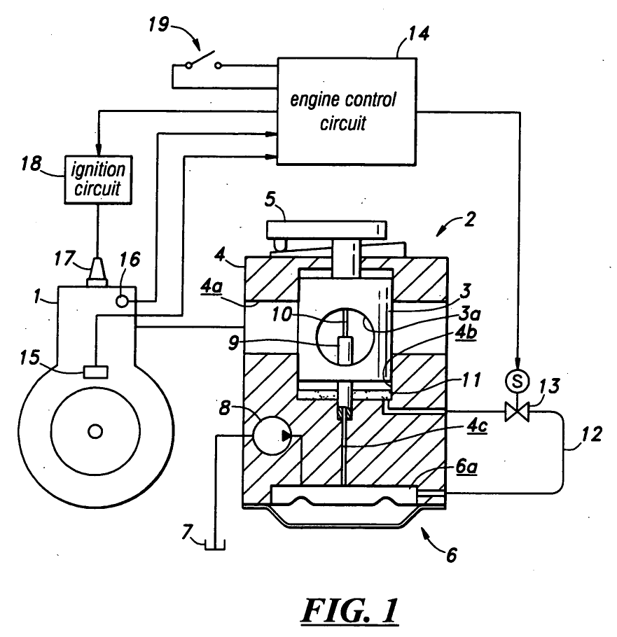

Referring in more detail to the drawings, FIG. 1 illustrates an automatic fuel enrichment starter system of a small internal combustion engine 1. The engine 1 receives a necessary amount of fuel-and-air mixture from a carburetor 2 connected to an intake port of the engine 1. The carburetor 2 of the illustrated embodiment uses a cylindrical rotary valve 3, but is not required to be a carburetor of this type. The rotary valve 3 may represent a throttle valve, a choke valve, or a combined choke and throttle valve. Other types of carburetors may be used, such as a butterfly valve and float bowl carburetor.

The carburetor 2 has an intake passage or bore 4a that extends across a main body 4 of the carburetor 2, and the rotary valve 3 is disposed in the intake bore 4a so as to extend perpendicularly across the intake bore 4a. The rotary valve 3 is received in a cylindrical valve recess 4b formed in the main body 4 so as to be rotatable around an axial line extending perpendicularly across the intake bore 4a and movable along the axial line. The rotary valve 3 is provided with a mixture passage 3a that extends perpendicularly with respect to the rotary axis of the valve 3 so that the degree of communication between the intake bore 4a and mixture passage 3a may be varied depending on the rotational angle of the rotary valve 3.

A rotary valve shaft is coaxially and integrally formed with the rotary valve 3 and extends out of the main body 4, and a lever 5 is attached to the projecting end of the rotary valve shaft. Typically, a throttle wire (not shown in the drawings) is connected to the lever 5, and the rotary valve 3 turns as the lever 5 turns. The lever 5 has a camming engagement with the opposing end surface of the main body 4 so that the lever 5 moves axially as it is turned, and this in turn causes an axial movement of the rotary valve 3.

A bottom part of the main body 4 accommodates a diaphragm type fuel adjusting or metering mechanism 6 to which fuel is supplied by a diaphragm type fuel pump 8 that draws fuel from an external fuel tank and feeds the fuel into a fuel chamber 6a of the fuel adjusting mechanism 6 and defined in part by a diaphragm. The fuel pump 8 is powered by pulsating pressure in a crankcase chamber of the engine 1. The fuel chamber 6a of the fuel adjusting mechanism 6 communicates with a fuel nozzle 9 that is coaxial with the rotary valve 3 and projects into the mixture supply passage 3a.

A primary fuel supply to the intake passage 4a is formed by a primary fuel passage 4c extending from the fuel chamber 6a to the fuel nozzle 9 and by the fuel nozzle 9 itself. A needle valve 10 for fuel adjustment projects coaxially from the wall of the mixture supply passage 3a opposite to the fuel nozzle 9, and extends into the fuel nozzle 9. As the needle valve 10 moves axially into and out of the fuel nozzle 9 because of the axial movement of the rotary valve 3, the opening area of a fuel ejection or discharge orifice in the peripheral wall of the fuel nozzle 9 changes so that the amount of fuel ejected or discharged may be controlled according to the opening area of the rotary valve 3.

The carburetor 2 is further provided with a mechanism for supplying an added or supplementary amount of fuel (i.e. start fuel) for starting the engine. A fuel reservoir 11 includes a ceramic or other porous material interposed between the lower surface of the rotary valve 3 and the bottom of the rotary valve recess 4b. The fuel reservoir 11 communicates with the fuel chamber 6a via a supplementary fuel supply passage 12 that is provided with a solenoid valve 13 in communication therewith. The solenoid valve 13 is controlled by an engine control circuit 14 which may be connected to one or both of a rotational speed sensor 15 for detecting the rotational speed of the engine 1 or a temperature sensor 16 for detecting the temperature of the engine 1. The engine control circuit 14 may also be connected to an ignition circuit 18 for providing electric current to a spark plug 17, and a start switch 19, which may be used with an automatic electric starter motor or may be used with a manual starter such as a recoil starter.

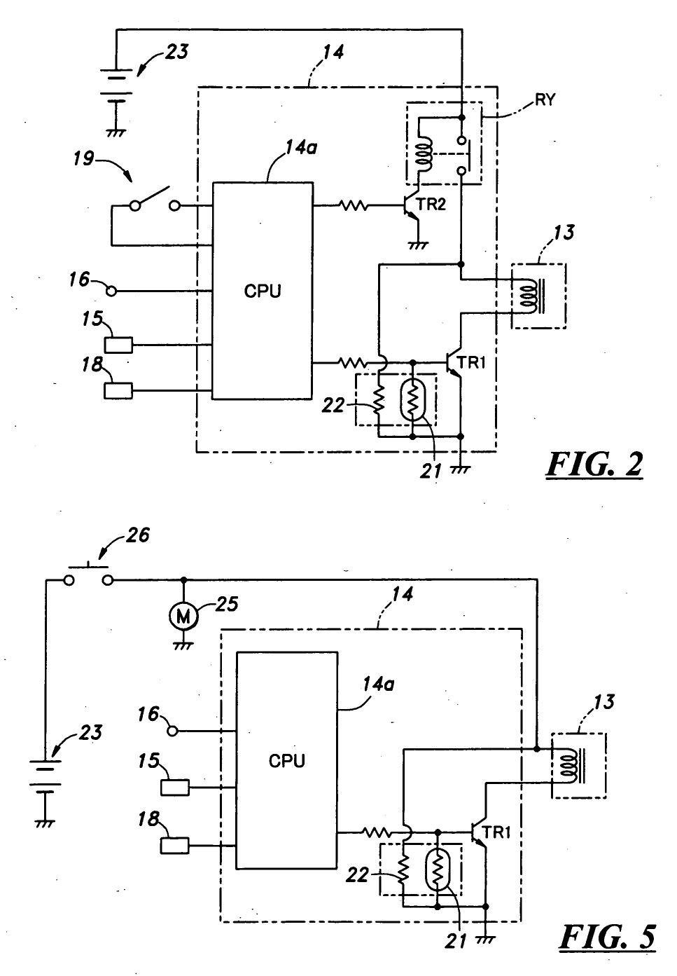

Referring to FIG. 2, a power source 23 such as a battery is used for storing and supplying electrical current to power the engine control circuit 14. More specifically, the battery 23 preferably powers the solenoid valve 13, a switching device RY such as a relay, and a heater element 22. In automatic starter configurations, the battery 23 may also be connected to an electric starter motor (not shown) for powering the starter motor.

In either automatic starter or manual starter configurations, the engine control circuit 14 includes a processor or central processing unit (CPU) 14a that executes control logic according to a program and the relay RY has a normally open contact set interposed between the battery 23 and one end of a solenoid or coil of the solenoid valve 13. The other end of the coil of the solenoid valve 13 is connected to a collector of a switching device TR1, such as a transistor, having an emitter that is grounded. The coil of the relay RY is energized and de-energized by another switching device TR2, such as a transistor, which is in turn turned on and off by the CPU 14a. Although transistors are disclosed as exemplary switching devices herein, it is contemplated that any suitable switching devices may be used.

The control line that leads from the CPU 14a to the base of the transistor TR1 is grounded via a thermistor 21. Adjacent to the thermistor 21 is provided a resistive heater element 22, which is connected in parallel with the coil of the solenoid valve 13 and the transistor TR1. The thermistor 21 and resistive heater element 22 may be integrated with the engine control circuit 14 as a single module if desired.

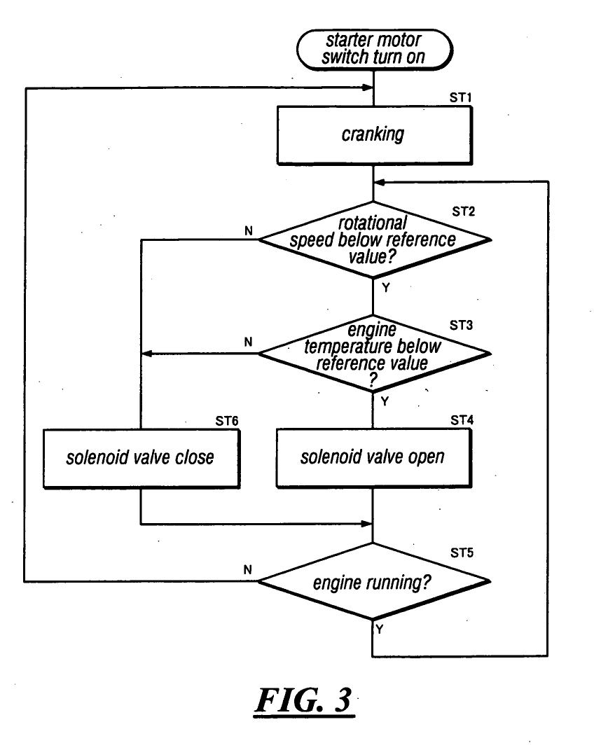

FIG. 3 illustrates a method of operation of the above described system during engine startup, wherein a fuel-and-air supply from a carburetor to an engine is automatically enriched. As represented by step ST1, the start switch 19 is turned on to enable cranking of the engine 1, such as by using an electric starter motor (not shown), or a manual recoil starter. Preferably, as shown in FIG. 2, the engine control circuitry 14 integrates the ignition control functions therein such that cranking of the engine 1 is carried out substantially simultaneously as the ignition circuit 18 controls ignition timing. Accordingly, the engine control circuitry 14 is preferably combined with ignition control circuitry 18 into a single unit to avoid the inconvenience of providing separate circuitry.

In any event, the CPU 14a forwards an ignition signal to the ignition circuit 18 according to ignition timing based on the engine rotational signal obtained by the rotational sensor 15 for cranking the engine 1. Using the ignition signal as a trigger signal, the CPU 14a turns on the transistor TR2. This in turn causes the relay RY to be energized by applying voltage from the battery 23 to the coil of the relay RY, thereby causing the normally open contact set of the relay RY to close. If the transistor TR1 is non-conductive, the coil of the solenoid valve 13 is not energized, and the solenoid valve 13 remains closed.

As shown by step ST2, once the engine 1 has started turning, the rotational speed of the engine 1 is detected by the rotational speed sensor 15, and it is then determined if the detected rotational speed of the engine 1 is below or less than a reference value, or if it is greater than or equal to the reference value. This reference value may correspond to a rotational speed slightly below the normal idling rotational speed. If the engine rotational speed is below the reference value in step ST2, the program flow advances to step ST3.

In step ST3, it is determined if the engine temperature detected by the temperature sensor 16 is below or less than a reference value, or if it is greater than or equal to the reference value. The reference value may be selected such as to allow a determination by the processor 14a whether the engine 1 is cold, such as when it has not been operated for a prolonged period of time, or if the engine 1 is warm, such as when the engine 1 was operating until a short time ago. For instance, the reference value may correspond to a temperature slightly below the temperature of the outer wall of the engine 1 at the time of idling. If the engine temperature is below this reference value in step ST3, the program flow advances to step ST4.

In step ST4, according to certain conditions, such as low rotational speed and/or low temperature, that led the program flow to this step, the CPU 14a feeds an ON signal to the transistor TR1 to produce a state that suits the cranking of the engine 1 under this condition(s). More specifically, the ground end of the coil of the solenoid valve 13 is grounded when the transistor TR1 is ON so as to energize the coil and thereby open the solenoid valve 13. Opening of the solenoid valve 13 opens the supplementary fuel supply passage 12 so that fuel from the fuel chamber 6a is allowed to flow into the fuel reservoir 11. The fuel in the fuel reservoir 11 is then drawn into the intake bore 4a via a gap defined between the outer circumferential surface of the rotary valve 3 and the inner circumferential surface of the rotary valve recess 4b. Instead of this gap, a separate passage could be provided between the fuel reservoir and the intake bore 4a. By thus supplying an added amount of fuel at the time of starting the engine, it becomes possible to readily start the engine 1 when it is cold.

In step ST5, it is determined if the engine 1 is running or not, such as by determining if the engine 1 is stationary or not, or rotating at or above a reference value, or the like, preferably according to output from the rotational speed sensor 15.

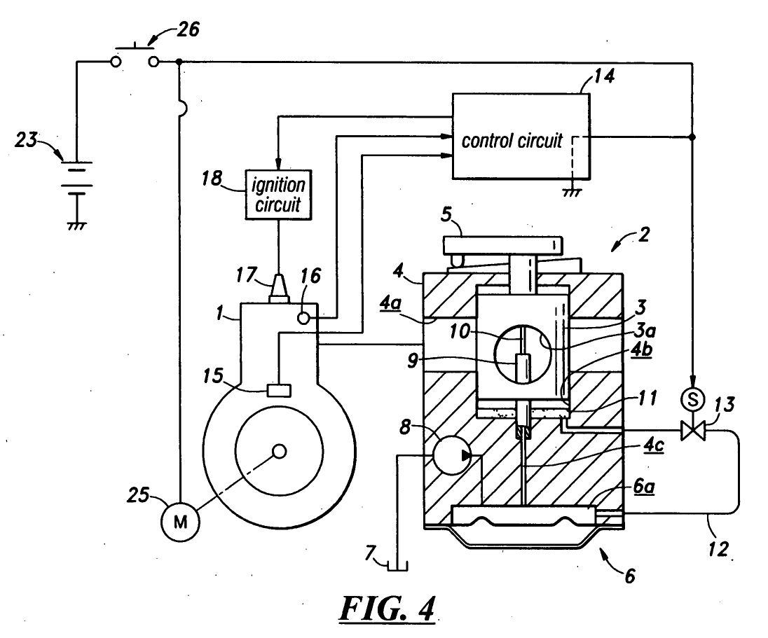

If, at step ST5, the engine 1 is not running, or is not running at or above a reference value, the program flow returns to step ST1, and cranking of the engine 1 may be resumed. If, in the case of an apparatus having an electric starter motor with an electric starter motor switch 26 (e.g. FIGS. 4 and 5), the engine 1 has already been running for some period of time but has ceased running, then at step ST1 an operator would again activate the electric starter motor switch 26.

If, however at step ST5, the engine 1 is running, or is running at or above a reference value, the program flow returns to step ST2.

If the engine speed is determined to be higher than the reference value in step ST2 or if the engine temperature is determined to be higher than the reference value in step ST3, then the program flow advances to step ST6. When rotational speed is at or above a reference value and/or engine temperature is at or above a reference value, then there is no need to supply the supplementary amount of fuel and, accordingly, the CPU 14a feeds an OFF signal to the transistor TR1 so that the solenoid valve 13 is de-energized and the solenoid valve 13 thus closes.

As a result, the communication between the fuel chamber 6a and fuel reservoir 11 via the supplementary fuel supply passage 12 is cut off so that fuel from the fuel reservoir 11 is not drawn into the intake bore 4a and only the normal or primary amount of fuel is ejected from the fuel nozzle 9. Advantageously, the solenoid valve 13 is closed immediately after the engine 1 has successfully started so that excessive enrichment or choking of the engine 1, and resulting flooding thereof, may be effectively avoided.

Also, the closing of the contact set of the relay RY during engine cranking causes electric current to be supplied to the resistive heater element 22 connected to the node between the contact set of the relay RY and the coil of the solenoid valve 13 so that the resistive heater element 22 produces heat. The quantity of produced heat progressively increases with time during engine cranking and, because the thermistor 21 is placed adjacent to this resistive heater element 22, the resistance of the thermistor 21 progressively decreases as it is heated by the resistive heater element 22. Accordingly, the thermistor 21 senses engine cranking via the resistive heater element 22.

The engine 1 may ultimately fail to start when cranked with the solenoid valve 13 open under a low rotational speed and low temperature condition, wherein steps ST1 to ST5 repeat as long as the engine 1 is not running. When such conditions persist, the supplementary supply of fuel may ordinarily flood the spark plug 17 of the engine 1, and could prevent or make difficult the starting of the engine 1.

However, the resistive heater element 22 starts producing heat as soon as engine cranking begins (i.e. when the start switch 19 is turned on), and the produced heat eventually reduces the electric resistance of the thermistor 21 to such an extent that electric current is diverted through the thermistor 21 away from the base of the transistor TR1, which eventually becomes non-conductive. As a result, the solenoid valve 13 closes and any further supply of the supplementary amount of fuel ceases. Therefore, if the engine 1 does not start until the time the solenoid valve 13 closes, according to the decrease of the electric resistance of the thermistor 21, then the supply of the supplementary amount of fuel is discontinued without regard to the control flow shown in FIG. 3.

If the start switch 19 is repeatedly or kept turned on, such as during cranking of the engine 1, the electric current continues to flow through the resistive heater element 22, and the transistor TR1 continues to be non-conductive because of the heated thermistor 21. In cases where the engine 1 fails to start, the engine operator may turn off, or stop pressing, the start switch 19. This allows the resistive heater element 22 to cool, thereby allowing the thermistor 21 to cool and return to the state where it ceases to draw the base current away from the transistor TR1. Thereafter, when the start switch 19 is turned on once again, the engine 1 may be cranked and, if the engine is cold, provided with the benefit of the supply of the supplementary amount of start fuel.

The time period that it takes for the thermistor 21 to draw the base current and turn the transistor TR1 non-conductive may be selected so as to be shorter than the time period that it takes for the spark plug 17 to be flooded. The time period may be selected by suitably selecting the resistive properties of the resistive heater element 22. Also, because it takes some time for the thermistor 21 to cool off and regain its normal state, when the engine 1 has failed to start, unnecessary opening of the solenoid valve 13 and excessive enrichment or choking of the engine 1 is avoided.

The time period during which the supplementary amount of start fuel is required to be supplied varies depending on the surrounding or ambient temperature. Preferably, the start fuel is required to be supplied for a relatively longer period of time when the surrounding temperature is low, and for a relatively shorter period of time when the surrounding temperature is high. The time period that it takes for the transistor TR1 to turn off is determined by the influence of the heat produced from the resistive heater element 22 on the thermistor 21. The intensity of heat transfer to the thermistor 21 depends on the surrounding temperature in such a manner that the time period for the transistor TR1 to turn off is relatively shorter at high temperatures and relatively longer at low temperatures. Therefore, the solenoid valve 13 may be closed relatively quickly when the surrounding temperature is high, and relatively slowly when the surrounding temperature is low so that the time duration of supplying the added amount of start fuel may be optimized for the given surrounding temperature.

Although it is preferred that the control of the solenoid valve 13 is based on both engine rotational speed as described in step ST2 and engine temperature as described in step ST3, it is also contemplated that the control may be based on either one individually. Accordingly, the hardware and control configurations may be simplified and manufacturing costs reduced.

FIGS. 4 and 5 illustrate another presently preferred form of an automatic fuel enrichment system, and related exemplary engine control circuit. This embodiment is similar in many respects to the embodiment of FIGS. 1 through 3 and like numerals between the embodiments generally designate like or corresponding elements throughout the several views of the drawing figures. FIG. 4 generally corresponds with FIG. 1 and FIG. 5 generally corresponds with FIG. 2. Additionally, the description of the common subject matter may generally not be repeated here.

The previously described relay RY and transistor TR2 are omitted and a positive terminal of the battery 23 is connected to a starter motor switch 26 for activating a starter motor 25. As shown in FIG. 4, the starter motor 25 is coupled to a crankshaft of the engine 1 in any suitable manner including but not limited to use of a centrifugal coupling, a stored-energy recoil-spring starter coupling, or the like. The starter motor switch 26 generally corresponds to the previously described starter switch 19, and is configured to be continually pressed or held down and thereby closed until the engine 1 starts and reaches an idling state.

As shown in FIG. 5, a downstream end or ground end of the starter motor switch 26 is connected to a first end of the coil of the solenoid valve 13. The other end of the coil of the solenoid valve 13 is connected to the collector of the switching device TR1. The resistive heater element 22 and the thermistor 21 are connected in circuit in a manner substantially similar to that as described previously.

This fuel enrichment start system for a carburetor of FIGS. 4 and 5, having the above described structure, functions substantially similarly to the previously described embodiment. Accordingly, step ST1 of the previously described method would be adapted such that when the starter motor switch 26 is turned ON the starter motor 25 cranks the engine 1 and, at substantially the same time, the battery voltage is applied to the solenoid valve 13 and the CPU 14a forwards an ignition signal to the ignition circuit 18 according to ignition timing based on the engine rotational signal obtained by the rotational sensor 15 for cranking the engine 1. But if the transistor TR1 is non-conductive (such as when the engine is warm), the coil of the solenoid valve 13 is not energized, and the solenoid valve 13 remains closed. In other words, the mode of controlling the solenoid valve 13 is also substantially similar to that of the previous embodiment. Thus, this embodiment eliminates the need for some component parts such as the relay RY and transistor TR2, wherein the circuit structure can be simplified and the manufacturing cost can be reduced.

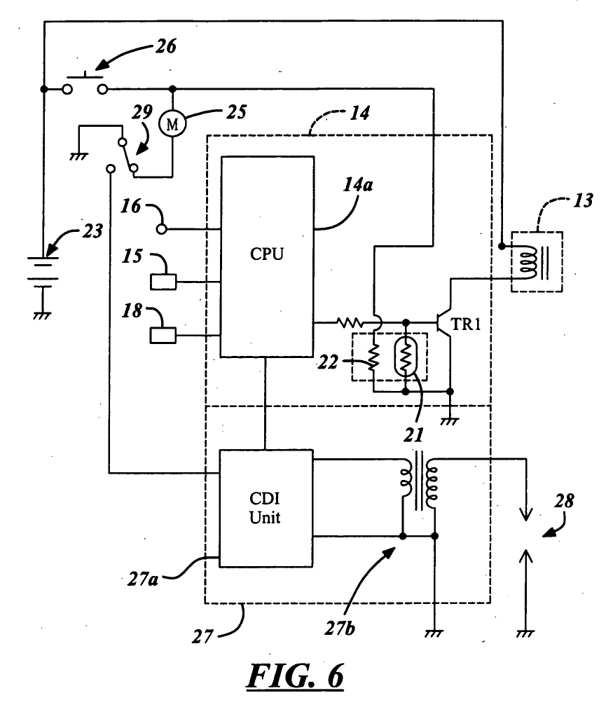

FIG. 6 illustrates another presently preferred form of an exemplary engine control circuit of an exemplary automatic fuel enrichment system such as that of FIG. 4. This form is similar in many respects to the forms of FIGS. 1 through 5 and like numerals between the forms generally designate like or corresponding elements throughout the several views of the drawing figures. FIG. 6 generally corresponds with FIGS. 2 and 5. Additionally, the description of the common subject matter may generally not be repeated here.

In the form of FIG. 6, the previously described relay RY and transistor TR2 are omitted and a positive terminal of the battery 23 is connected to the starter motor switch 26 for activating the starter motor 25. Here, however, a capacitive discharge ignition (CDI) circuit 27 includes a CDI device 27a connected to the processor 14a for powering the processor 14a, preferably via a rectifier device or diode (not shown).

CDI devices are widely used in spark-ignited internal combustion engines. As one example, CDI devices include a main capacitor (not shown), which during each cycle of the engine 1, is charged by an associated generator or charge coil (not shown) and is later discharged through a step-up transformer or ignition coil 27b to fire a spark plug 28. CDI devices typically have a stator assembly (not shown) including a ferromagnetic stator core (not shown) having wound thereabout the charge coil and the ignition coil 27b with its primary and secondary windings. A permanent magnet assembly (not shown) is typically mounted on an engine flywheel (not shown) to generate current pulses within the charge coil as the permanent magnet is rotated past the ferromagnetic stator core. The current pulses produced in the charge coil are used to charge the main capacitor which is subsequently discharged upon activation of a trigger signal. The trigger signal may be supplied by a trigger coil (not shown) that is also wound around the stator core, when the permanent magnet assembly cycles past the stator core to generate pulses within the trigger coil. Upon receipt of the trigger signal, the main capacitor discharges through the primary winding of the ignition coil 27b to induce a current in the secondary winding that is sufficient to cause a spark across a spark gap of the spark plug 28 to ignite a fuel and air mixture within a combustion chamber of the engine. Such CDI devices are generally known to those of ordinary skill in the art of engine ignition systems and any suitable CDI device may be used.

Additionally, an ignition switch 29 is connected to ground and to the CDI device 27a for preventing electric discharge across the spark plug gap when the ignition switch 29 is turned off so that the ignition coil 27b does not generate current in its secondary winding as the engine flywheel rotates. Also, an engine start switch such as the starter motor switch 26 is arranged in series between the battery 23 and the ignition switch 29 for grounding the electric starter motor 25 when the ignition switch 29 is turned on to enable current to flow through the motor 25 when the engine start switch 26 is activated.

Here, however, the coil of the solenoid valve 13 is not in a switched connection to the battery 23. Rather, the solenoid valve 13 is directly connected to the battery 23 and is only switched on and off by operation of the transistor TR1.

In operation, this fuel enrichment system functions according to the previously described method depicted in FIG. 3, but using starting switch circuitry different than the previously described embodiments.

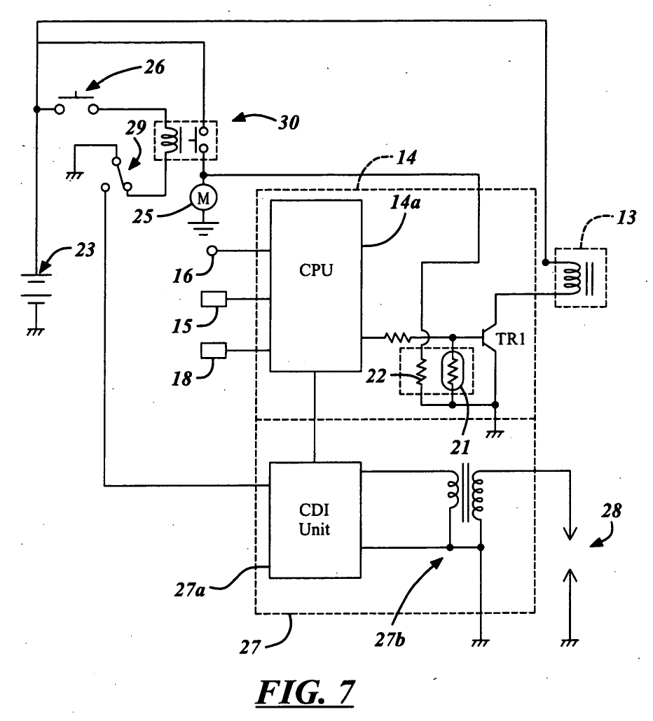

FIG. 7 illustrates a modification of the exemplary engine control circuit of FIG. 6. This form is similar in many respects to the form of FIGS. 1 through 6 and like numerals between the forms generally designate like or corresponding elements throughout the several views of the drawing figures. FIG. 7 generally corresponds with FIGS. 2, 5, and 6. Additionally, the description of the common subject matter may generally not be repeated here.

Here, the electric starter motor 25 is not directly connected to the engine start switch 26 as with the form of FIG. 6. Rather, a relay 30 is provided therebetween and has a coil arranged in series between the engine start switch 26 and the ignition switch 29 and has a contactor arranged in series between the battery 23 and the electric starter motor 25. The electric starter motor 25 is grounded and current flows through the motor 25 when the ignition switch 29 is turned on and the engine start switch 26 is closed.

Again, in operation, this fuel enrichment system functions according to the previously described method depicted in FIG. 3, but using starting switch circuitry somewhat different than the previously described forms.

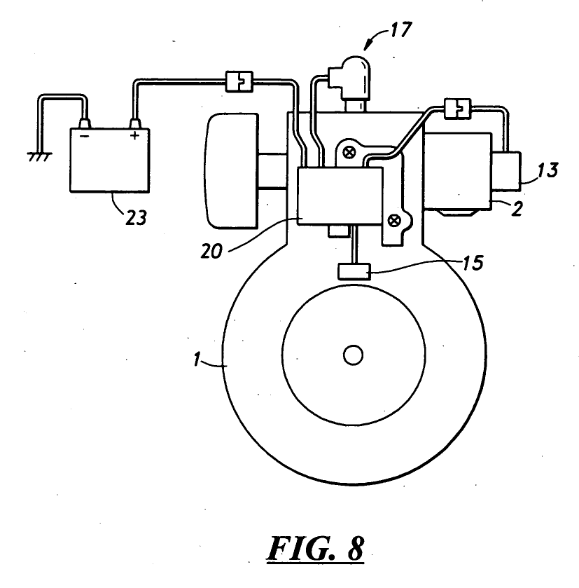

FIGS. 8 through 12 generally refer to another presently preferred embodiment of a supplementary fuel supply system for a carburetor. This embodiment is similar in many respects to the embodiment of FIGS. 1 through 7, which description is incorporated by reference herein, and like numerals between the embodiments generally designate like or corresponding elements throughout the several views of the drawing figures. Additionally, the description of the common subject matter generally may not be repeated here.

Referring to FIG. 8, an engine 1 receives a fuel and air mixture from a carburetor 2 communicating with an intake port (not shown) of the engine 1. A solenoid valve 13 associated with the carburetor 2 is controlled by an engine control unit 20. The control unit 20 is powered by a battery 23 and receives input from an engine rotation sensor 15 and produces output to a spark plug 17 for igniting the fuel and air mixture in the engine 1.

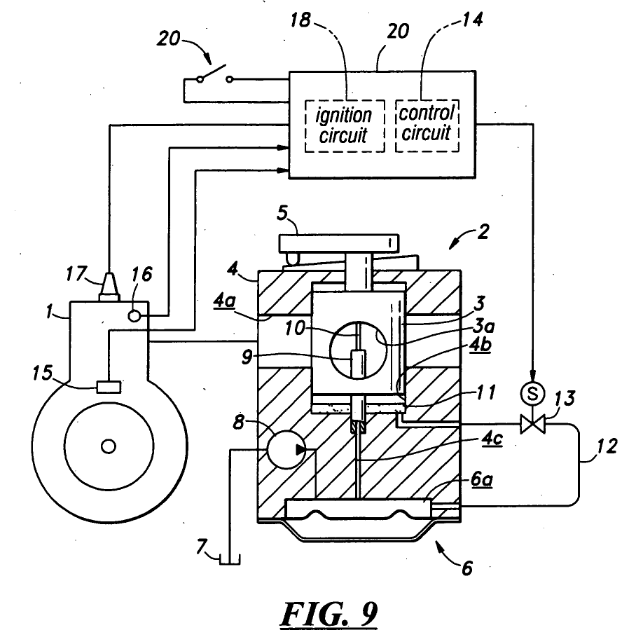

Referring to FIG. 9, the carburetor 2 includes a main body 4 having an intake bore 4a extending through the main body 4 and a cylindrical rotary valve 3 extending perpendicularly across the intake bore 4a. The rotary valve 3 is received in a cylindrical valve support chamber 4b formed in the main body 4. The rotary valve 3 is rotatable within the support chamber 4b and extends perpendicularly across the intake bore 4a and is slidable in the axial direction. The rotary valve 3 is formed with a mixture passage 3a extending perpendicularly with respect to the axis thereof so that the degree of communication between the intake bore 4a and mixture passage 3a may be varied depending on the rotational angle of the rotary valve 3.

The carburetor 2 also includes a lever 5 fixed to a projecting end of a rotary valve shaft, which is coaxially fixed to the rotary valve 3 and extends out of the main body 4. A throttle wire (not shown) can be connected to the lever 5 so as to turn the rotary valve 3. The lever 5 is also engaged by a cam formed on an end surface of the main body 4 so as to be displaced in the axial direction as the lever 5 turns.

The carburetor 2 also includes a bottom portion of the main body 4 provided with a diaphragm fuel adjusting mechanism 6, and a fuel pump 8 such as a diaphragm pump for drawing fuel from an external fuel tank 7 to a fuel chamber 6a defined by a diaphragm of the fuel adjusting mechanism 6. The fuel pump 8 is actuated by a pulsating pressure of a crankcase chamber of the engine 1. The fuel chamber 6a of the fuel adjusting mechanism 6 communicates with a fuel nozzle 9 disposed coaxially with respect to the rotary valve 3 and projecting into the mixture passage 3a.

A primary fuel supply passage is defined by a fuel passage 4c extending from the fuel chamber 6a to the nozzle 9, and by the fuel nozzle 9. A fuel metering needle valve 10 projects into the fuel nozzle 9 and is coaxially fixed to the rotary valve 3 opposite to the fuel nozzle 9. As the fuel metering needle valve 10 moves in the axial direction as a result of the axial movement of the rotary valve 3 by the cam, the opening area of a fuel ejecting orifice formed in the peripheral wall of the fuel nozzle 9 is varied and fuel is supplied by an amount corresponding to the extent of opening of the valve 3.

The carburetor 2 additionally includes a supplementary fuel supply system for increasing the supply of fuel to the engine 1, such as when cranking the engine 1. Between the bottom surface of the rotary valve 3 and the valve support chamber 4b is interposed a fuel reservoir 11, which can include a ceramic or other porous material to store supplementary fuel, such as for adding the supplementary fuel when cranking the engine. The fuel reservoir 11 and fuel chamber 6a communicate with each other via a supplementary fuel supply passage 12. The solenoid valve 13 is provided in an intermediate part of the supplementary fuel supply passage 12.

The solenoid valve 13 is opened and closed by a control circuit 14. The engine 1 is equipped with the rotation sensor 15 for detecting the rotation of the engine 1 and an engine temperature sensor 16 for detecting the temperature of the engine 1. The engine 1 is also provided with the spark plug 17 which is controlled by an ignition circuit 18 such as a CDI circuit.

The control unit 20 can be carried by any suitable part of the engine 1, and the control circuit 14 and ignition circuit 18 can be incorporated in the control unit 20 as an integral module. Accordingly a start control program may be incorporated for ignition control and the number of component parts can be reduced and wiring can be simplified. A power line of the control unit 20 is connected to a battery 1, and the control unit 20 is also connected in any suitable manner to the solenoid valve 13, rotation sensor 15 and spark plug 17.

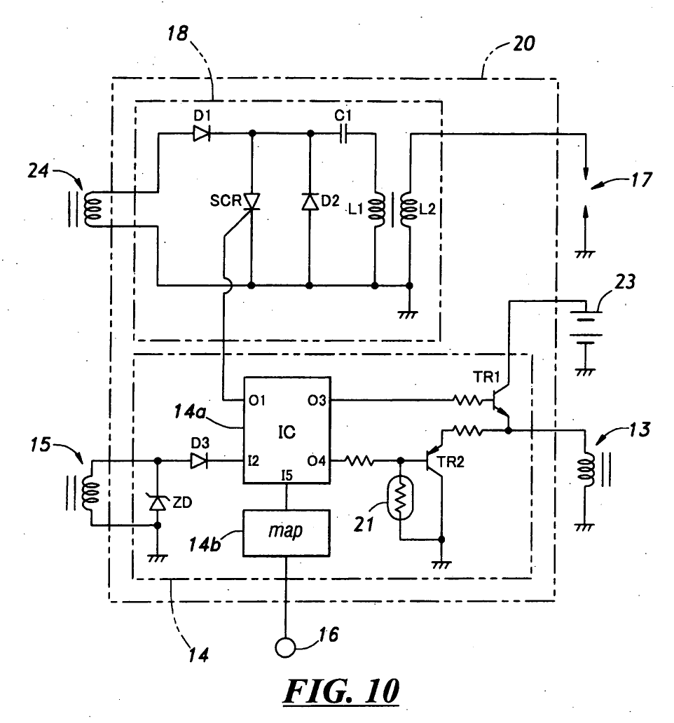

Referring to FIG. 10, in the ignition circuit 18, a capacitor C1 is connected to one terminal of an exciter coil 24 via a diode D1, and another terminal of the exciter coil 24 is grounded. The exciter coil 24 can be any suitable coil and can be part of the rotation sensor 15. A thyristor SCR and diode D2 are connected between the diode D1 and capacitor C1. A primary coil L1 of an ignition coil or transformer is connected to the capacitor C1 and the ground, and a secondary coil L2 of the ignition coil is connected to the spark plug 17.

The control circuit 14 can include a CPU or an integrated circuit (IC) 14a that executes computer readable instructions, and a normally open npn transistor TR1 whose collector is connected to the battery 23. The emitter of the npn transistor TR1 is connected to a coil of the solenoid 13 as well as to the collector of a normally closed pnp transistor TR2 so that the pnp transistor TR2 is controlled according to an output signal from an output terminal O4 of the IC 14a. More specifically, the solenoid 13 is energized or opened when the npn transistor TR1 is conductive (on or closed) and the pnp transistor TR2 is non-conductive (on or open), and is de-energized or closed when the npn transistor TR1 is non-conductive (off or open) or when the pnp transistor TR2 is conductive (off or closed). Those skilled in the art will recognize that thyristors and transistors are exemplary switching devices, and that any suitable switching devices can be used.

The control line extending from the output terminal O4 of the IC 14a to the base of the transistor TR2 is grounded via a thermistor 21. This thermistor 21 may be incorporated in the integral module of the control circuit 14. The control unit 20 can be carried in any suitable manner by the engine 1, and can be attached to a suitable part such as an outer wall surface of a cylinder block of the engine 1 so that the thermistor 21 is adapted to directly measure the engine temperature and allow the engine temperature to be measured as a change in the electric resistance thereof.

The gate of the thyristor SCR is connected to an output terminal O1 of the IC 14a, and an input terminal 12 of the IC 14a is connected to an end of a signal coil of the rotation sensor 15 via a diode D3. The other end of the signal coil of the rotation sensor 15 is grounded. A zener diode ZD is connected across the terminals of the signal coil to clip the voltage at a fixed level. An input terminal 15 of the IC 14a is connected to a map module 14b that stores data as a map that gives a prescribed accumulated value of the number of cranking rotations in relation with the engine temperature. Therefore, the engine temperature sensor 16 is connected to the map module 14b to feed the engine temperature thereto. The map module 14b may be any suitable device(s), such as circuit(s), memory, software, or the like.

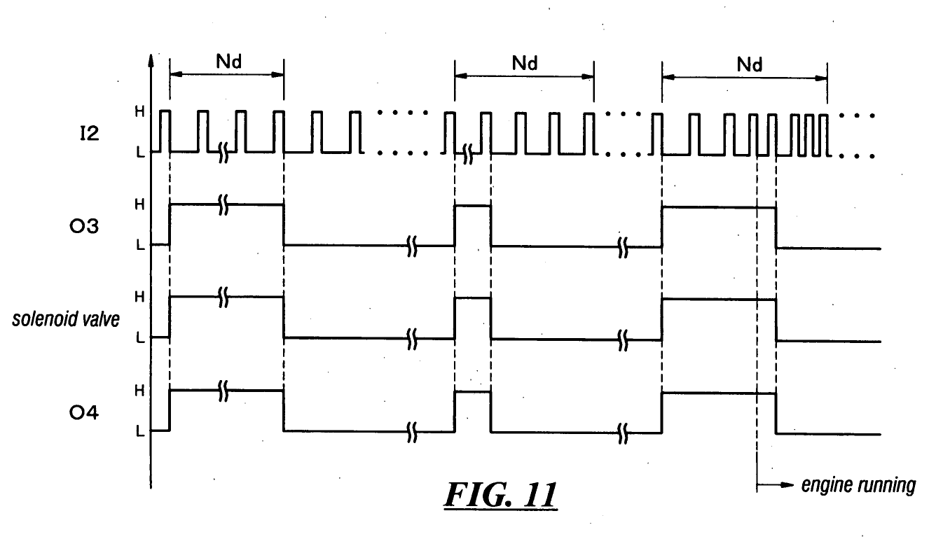

The mode of operation of the illustrated supplementary fuel supply system for the carburetor 2 is now described with reference to FIGS. 8-10, and the timing chart of FIG. 11. First, the engine 1 is cranked in any suitable manner, such as with an electric starter motor, or a manual recoil starter. The control unit 20 may be configured to operate according to a detection signal from the rotation sensor 15. An ignition signal is forwarded from the output terminal O1 of the IC 14a to the gate of the thyristor SCR of the ignition circuit 18 according to a rotation reference signal obtained from the speed sensor 15. The ignition circuit 18 receives electric current generated by the exciter coil 24, and energizes the spark plug 17 at a prescribed timing by selectively turning on and off the thyristor SCR and thereby charging and discharging the capacitor C1.

The IC 14a accumulates the number of revolutions of the engine 1 according to a rotation reference signal of the rotation sensor 15, as depicted by the H signal of the I2 pulse train in FIG. 11. The IC 14a produces an ON signal from the output terminal O3 upon counting a first pulse of the rotational reference signal. The IC 14a then compares the accumulated number of revolutions of the engine 1 with a prescribed value, such as Nd in FIG. 11, of the map module 14 and turns off the output from the output terminal O3 when the accumulated number of revolutions has reached the prescribed value, Nd. Therefore, the solenoid valve 13 opens from the time of counting the first pulse of the rotation reference signal until the accumulated number of engine revolutions reaches the prescribed value Nd.

When cold starting the engine 1, the solenoid valve 13 is opened so as to communicate the supplementary fuel supply passage 12 and permit the supply of fuel from the fuel chamber 6a to the fuel reservoir 11. The supplementary fuel stored in the fuel reservoir 11 is drawn into the intake bore 4a via a gap between the outer circumferential surface of the rotary valve 3 and the inner circumferential surface of the valve support chamber 4b. In other words, there is a sloppy, loose, or sliding fit between the rotary valve 3 and the valve support chamber 4b. By thus increasing the supply of fuel when cold starting the engine 1, the starting of the engine 1 is facilitated even when the engine 1 is cold.

An ON signal is produced from the output terminal O4 as well as from the output terminal O3 of the IC 14a. The pnp transistor TR2 is kept turned off as long as an ON signal is produced from the output terminal O4. This is a typical transistor circuit where the voltage between the base and ground is required to be less than 1.2V for the pnp transistor TR2 to become conductive. Because the output voltage from the output terminal O4 is close to 5 volts, the voltage between the base of the pnp transistor TR2 and ground is kept at a high level and the pnp transistor TR2 is kept in a nonconductive state until the resistive value of the thermistor 21 drops below a certain level. The non-conductive state of the pnp transistor TR2 lasts until the output from the output terminal O4 has heated up the thermistor 21 by flowing through the thermistor 21 to such an extent that the base current for the pnp transistor TR2 is drawn to the ground via the thermistor 21. Accordingly, even when the engine 1 is cold, as soon as the thermistor 21 is heated up and the resistive value of the thermistor 21 has dropped to a certain level, the pnp transistor TR2 closes and conducts so as to ground the electric current supplied to the solenoid valve 13 and close the solenoid valve 13. Therefore, even when the engine 1 fails to start, an excessive supply of fuel to the engine can be prevented to avoid flooding and ensure a quick subsequent starting of the engine 1.

Furthermore, the thermistor 21 preferably has a relatively low resistive value. Accordingly, when the engine temperature is warm or when the surrounding temperature is high, the pnp transistor TR2 grounds the electric current away from the solenoid valve 13. In such a case, the solenoid valve 13 is prevented from opening, and the supply of an increased amount of fuel can be avoided.

Because the closing of the solenoid valve 13 shuts off the communication between the fuel chamber 6a and fuel reservoir 11 via the supplementary fuel supply passage 12, the fuel of the fuel reservoir 11 ceases to be drawn into the intake bore 4a, and the fuel is supplied through the primary fuel supply passage. Therefore, the system can prevent any supplementary fuel supply when starting the engine under high temperature conditions, such as when the engine is still warm from recent operation and/or when ambient temperatures are high.

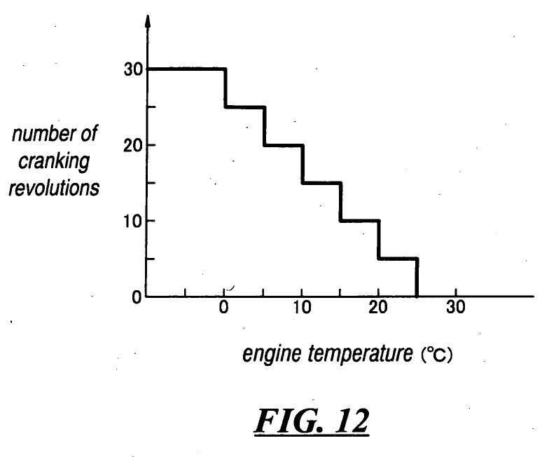

Again, the IC 14a continuously compares the accumulated number of revolutions of the engine 1 with a prescribed value, such as Nd, and turns off the output from the output terminal O3 when the accumulated number of revolutions has reached the prescribed value Nd. The prescribed number of accumulated revolutions Nd can be selected such that this number can be reached before the thermistor 21 causes the solenoid valve 13 to close when cold starting the engine. For example, the accumulated number of revolutions can be on the order of 30, such as at 0° C. or lower, for instance. The prescribed value that is to be compared with the accumulated number of engine revolutions may be varied depending on the engine temperature detected by the engine temperature sensor 16. More specifically, the data map stored in the map module 14b may be made as illustrated in FIG. 12 in which the ordinate is the engine temperature and the abscissa is the accumulated number of revolutions of the engine 1. In this case, the prescribed value Nd is 30 when the engine temperature is 0° C. or lower, and is reduced by five revolutions with each 5° C. increase in the engine temperature. Therefore, when the engine temperature is 25° C. or higher, the prescribed value is 0, and the supply of fuel to the engine 1 is not increased when cranking the engine 1. Accordingly, once the engine 1 is successfully started, the solenoid valve 13 is closed and over-choking can be effectively avoided.

If the engine temperature reaches a prescribed temperature value, for example 25° C., before the accumulated engine revolutions reaches the prescribed value Nd, the output of the output terminal O4 is turned off and the solenoid valve 13 closes (as shown in the middle of FIG. 11). Once the engine temperature rises to a sufficiently high level to indicate that the engine 1 has warmed up, no further supply of supplementary fuel is required and the supplementary fuel supply is terminated as described above.

Also, if the engine 1 starts operating normally, such as during idling, before the accumulated engine revolutions reach the prescribed value when cranking the engine 1, then this condition can be determined from a rapid rise in the rotational speed of the engine 1. In this case also, there is no need for the supplementary fuel supply and the solenoid valve 13 is closed as shown at the right side of FIG. 11.

Thus, according to the description above, a cold engine can be started in a favorable manner with the benefit of a rich mixture. This is because supplementary fuel is supplied in addition to a regular supply of fuel by opening the solenoid valve when the rotation sensor detects the engine is being rotated at a rotational speed that is lower than an idling rotational speed adequate to warm up the engine. Upon failure to start the engine, if the start fuel were to be further supplied while cranking the engine, it would become even more difficult to start the engine because of engine flooding. However, according to the present disclosure, the number of engine revolutions are accumulated while the engine is cranked, and once the revolutions reach or exceed a prescribed value, the solenoid valve is closed and any further supply of the start fuel is avoided. The prescribed value is selected so as to avoid the continued supply of an increased amount of fuel that would flood the engine and inhibit starting or restarting of the engine. Therefore, an excessive supply of supplementary fuel can be avoided upon failure to start the engine, and this facilitates subsequent starting of the engine by avoiding the flooding of the spark plug.

Moreover, the prescribed value of engine revolutions may be changed depending on engine temperature. Accordingly, engine temperature may be detected and the solenoid valve can be closed if the detected engine temperature exceeds a prescribed temperature value. For instance, the prescribed value of engine revolutions may be relatively high when the temperature is low and it is harder to start the engine so that an adequate period of time may be given to the cranking of the engine. Conversely, the prescribed value may be relatively low when the temperature is high and it is easier to start the engine so that the supply of excessive start fuel is avoided.

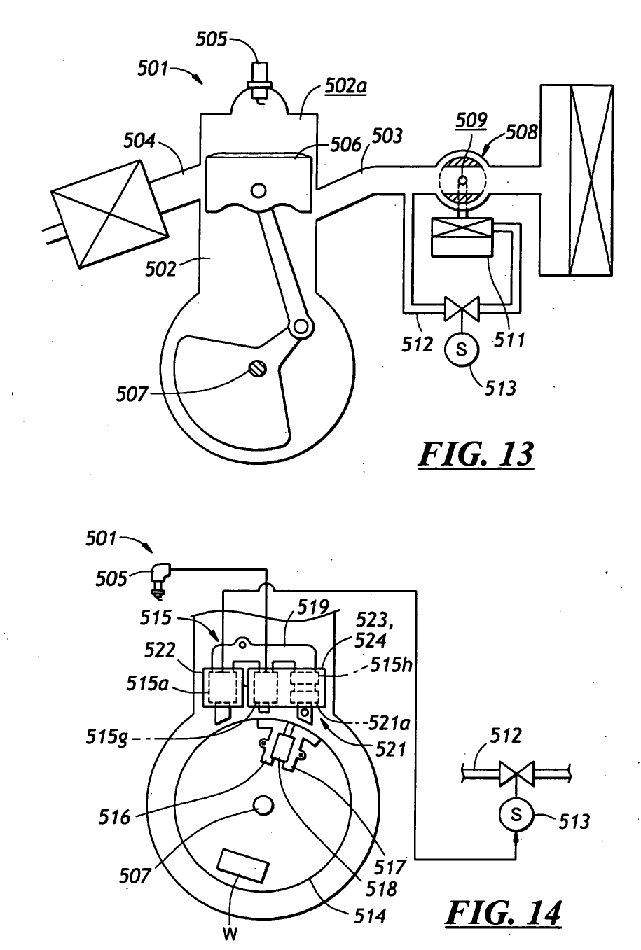

FIGS. 13 through 19 generally refer to another presently preferred embodiment of a supplementary fuel supply system for a carburetor. This embodiment is similar in many respects to the embodiments of FIGS. 1 through 7, and FIGS. 8 through 12, which descriptions are incorporated by reference herein. Additionally, the description of the common subject matter generally may not be repeated here.

Referring now to FIG. 13, an intake passage 503 and an exhaust passage 504 are connected to a cylinder block 502 of an engine 501, and a spark plug 505 is provided on a cylinder head of the engine 501. In operation, reciprocation of a piston 506 in a cylinder 502 of the engine 501 causes rotation of a crankshaft 507. Any suitable two-stroke engine can be used.

The intake passage 503 is provided with a throttle valve 508, such as rotary valve that moves axially as it rotates. A fuel supply nozzle 509 is provided coaxially with respect to the throttle valve 508 so that the amount of fuel supply may be adjusted by the axial movement of the throttle valve 508. Accordingly, an amount of fuel that corresponds to the extent of opening of the throttle valve 508 is drawn into the intake passage 503, and a fuel-and-air mixture is supplied through the crankcase and a transfer passage to the cylinder 502a of the engine 501.

A fuel reservoir 511 is configured as a fuel source for supplying fuel to the fuel supply nozzle 509 and communicates with the intake passage 503 via a communication conduit 512 serving as a fuel communication passage. A solenoid valve 513 is provided in an intermediate part of the communication conduit 512 to selectively establish communication with the intake passage 503 by the communication conduit 512. One or more of the throttle valve 508, nozzle 509, reservoir 511, conduit 512, and solenoid 513 can be part of a carburetor for the engine 501.

Referring to FIG. 14, an outer face of the engine 501 is provided with a flywheel 514 fixedly attached to the crankshaft 507 for rotation in unison therewith and a magneto or power generator and control unit 515 is attached to the engine 501 adjacent to an outer periphery of the flywheel 514. The power generator and control unit 515 includes an E-shaped ferrous lamstack bracket 519 attached to an outer face of the engine 501 and circuit components are attached to this bracket 519. A pair of pole components 516 and 517 are attached to an outer peripheral part of the flywheel 514 and are circumferentially spaced from each other, and a permanent magnet 518 is interposed between the two pole pieces in such a manner that the faces of the pole components 516 and 517 facing the outer periphery of the flywheel 514 are of opposite polarities. A counterweight W is fixedly attached to the flywheel 514 diametrically opposite to the pole components 516 and 517 and permanent magnet 518 for balancing the flywheel assembly.

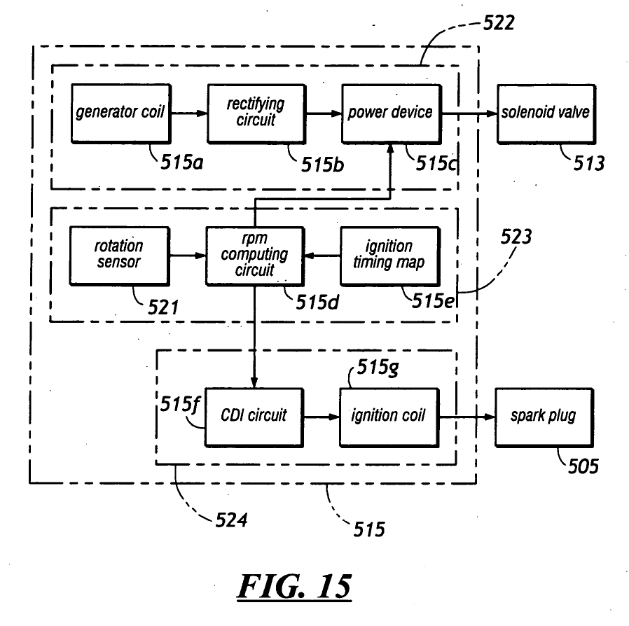

As shown in FIG. 15, the power generator and control unit 515 includes a solenoid valve driver circuit 522, an ignition timing control circuit 523, and an ignition circuit 524. The driver circuit 522 includes a generator coil 515a, a rectifying circuit 515b for rectifying AC power generated by the generator coil 515a, and a power device 515c including a thyristor or the like for selectively applying the rectified voltage produced by the rectifying circuit 515b to the solenoid valve 513. The ignition timing control circuit 523 includes a rotational speed computing circuit 515d connected to a rotation sensor 521, for feeding an ON/OFF signal to the power device 515c, and an ignition timing map 515e for storing ignition timing signal data and being connected to the rotational speed computing circuit 515d. The ignition circuit 524 includes a CDI circuit 515f for receiving an ignition control signal from the rotational speed computing circuit 515d according to an ignition timing signal forwarded from the ignition timing map 515e, and an ignition coil 515g for supplying a high voltage to the spark plug 505 according to an output signal from the CDI circuit 515f.

The generator coil 515a, ignition coil 515g and a coil 521a of the rotation sensor 521 are each wound around a corresponding leg of the lamstack bracket 519 from left to right as seen in FIG. 14. The free end of each leg extending from the bracket 519 opposes the outer circumferential surface of the flywheel 514 and defines a small gap. Also, an exciter coil 515h for the CDI circuit 515f is wound around the right leg of the bracket 519. As the flywheel 514 rotates and each pole component 516, 517 passes by the leg of each coil 515a, 515g, 515h and 521a, an electric current is induced in the corresponding coil 515a, 515g, 515h and 521a.

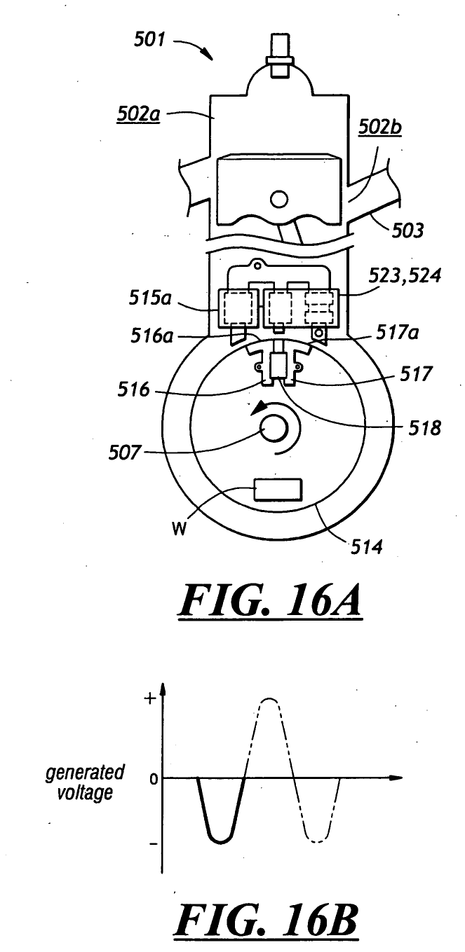

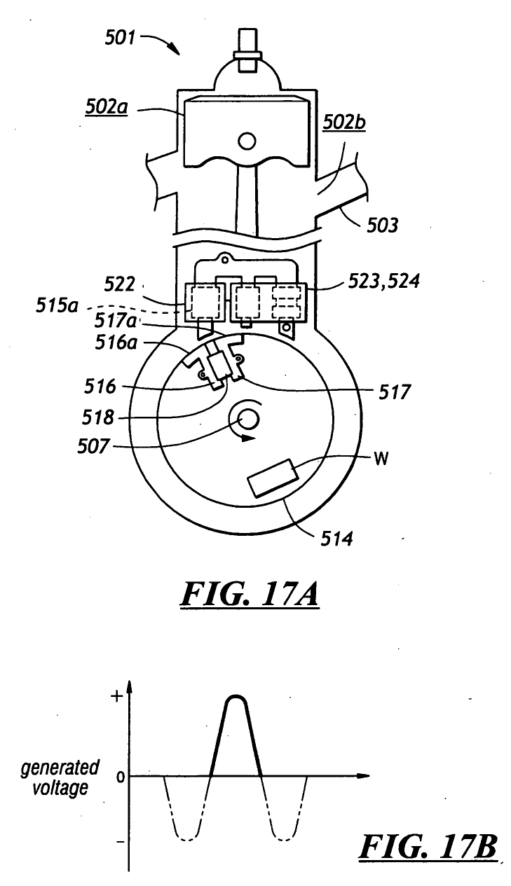

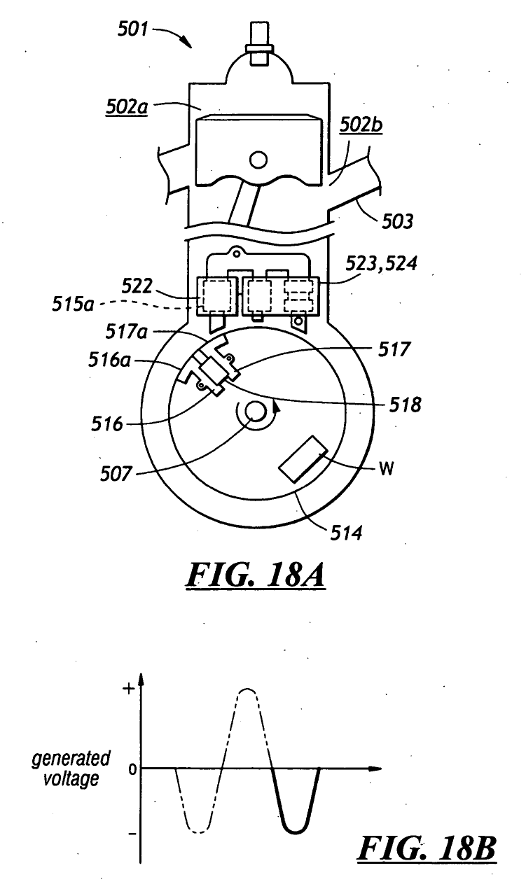

In particular, the generator coil 515a generates power for the solenoid valve 513. As a magnetic pole 516a on the pole component 516, or the leading pole with respect to rotation, passes by the generator coil 515a as shown in FIG. 16A, a negative signal is generated as indicated by the solid line in FIG. 16B. Next, as an intermediate portion between magnetic poles 516a and 517a of the pole components 516 and 517 passes by the generator coil 515a as shown in FIG. 17A, the magnetic poles 516a and 517a jointly provide magnetic flux that passes through the generator coil 515a so that a positive signal which is greater in magnitude that that shown in FIG. 16B is generated as indicated by the solid line in FIG. 17B. Finally, as the pole 517a passes by the generator coil 515a as shown in FIG. 18A, a negative signal similar to that shown in FIG. 16B is generated as indicated by a solid line as shown in FIG. 18B.

When the engine is operating under a normal condition, a voltage waveform similar to that mentioned above is also generated in the ignition coil 515g. The CDI circuit 515f causes the voltage generated from the ignition coil 515g to be applied to the spark plug 505 to produce an electric discharge according to the ignition timing determined by the rotational speed computing circuit 515d.

In an exemplary conventional device such as a grass trimmer, a small two-stroke engine may typically operate at a constant rotational speed of about 8,500 rpm, but the rotational speed may reach 12,000 rpm under no load conditions. Under hot, no-load conditions, self-ignition may occur, wherein ignition timing gets out of control, and the rotational speed of the engine may rise to 14,000 rpm to 15,000 rpm. When the engine continues to be operated at such overspeed conditions, the engine could seize or otherwise become damaged.

However, according to the disclosed controls, the rotational speed of the engine 501 is monitored first, and once a prescribed relatively high (such as 10,000 to 12,000 RPM) rotational speed is detected, the solenoid valve 513 is opened so that fuel may be supplied to the intake passage 503, in addition to a normal supply of fuel, via the communication conduit 512 and development of hot spots may be avoided by cooling the interior of the cylinder 502a with the supplementary fuel. For instance, the rotational speed can be monitored by using the coil 521a of the rotational sensor 521 and computing the rotational speed with the rotational speed computing circuit 515d.

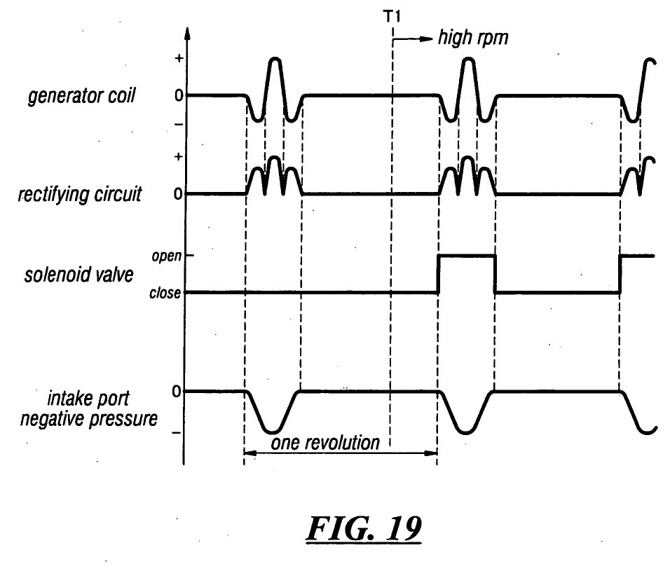

As shown in FIG. 19, a voltage waveform is generated, such as by the generator coil 515a, for each revolution of the crankshaft, and a positive waveform shaped by the rectifying circuit 515b is forwarded to the power device 515c. If it is detected that the engine speed has reached the prescribed value at timing T1 in FIG. 19, for instance, an ON signal is forwarded from the rotational speed computing circuit 515d to the power device 515c, and the voltage generated from the generator coil 515a is applied to the solenoid valve 513 via the power device 515c at the time at which the voltage is generated from the generator coil 515a to thereby actuate or open the solenoid valve 513.

In particular, the generator coil 515a is positioned in such a manner that the timing of voltage generation from the generator coil 515a is synchronized with generation of negative pressure in the intake port 502b. The negative intake port pressure corresponds to timing of supplying a fuel-and-air mixture into the cylinder 502a. The opening and closing of the intake port 502b is illustrated across FIGS. 16A, 17A, and 18A. With the arrangement described above, the solenoid valve 513 can be opened in synchronism with the timing of supplying the fuel-and-air mixture into the intake port 502b and, thus, no battery for powering the solenoid valve 513 is required.

With the previously described grass trimmer example, an exemplary prescribed rotational speed may be about 11,000 rpm. But any suitable prescribed rotational speed(s) may be used, such as any suitable normal operating value or range, for example, approximately 10,000 rpm to 11,500 rpm such as when the maximum speed of the engine under no load condition is 12,000 rpm. By thus selecting the prescribed rotational speed at any level that is higher than a normal operating rotational speed (e.g. 8,500 rpm), but lower than a maximum no-load condition rotational speed (e.g. 12,000 rpm), the engine 501 may be operated even under no load condition with reduced or eliminated self-ignition.

Thus, according to the present disclosure, an interior of an engine cylinder and associated piston can be suitably cooled and generation of hot spots that could cause an uncontrollable rise in the engine rotational speed can be avoided. This is because the supplementary fuel supply passage and solenoid valve are provided for supplying supplementary fuel to the engine in addition to a normal supply of fuel, wherein the solenoid valve closes when the engine is operating at a normal rotational speed and opens when the engine is operating at a rotational speed higher than a prescribed value. Therefore, the supply of fuel can be increased under high speed conditions to prevent hot spots and self-ignition, and can be reduced under normal operating conditions wherein the resulting combustion at an approximately stoichiometric ratio can effectively minimize hydrocarbon and carbon monoxide contents in the exhaust gas so as enable the engine to meet tougher emission regulations.

Moreover, the solenoid valve can be controlled according to the rotation of the engine. More specifically, the solenoid valve can be powered by electricity generated by a permanent magnet rotating in unison with the crankshaft and a generator coil that cooperates with the magnet. Accordingly, the supplementary fuel can be supplied in an optimum fashion by synchronizing the opening of the solenoid valve with the supplying of the fuel-and-air mixture to the combustion chamber of the engine. This can be accomplished by positioning the generator coil in such a manner that the generation of voltage from the generator coil may be synchronized with the intake stroke of the engine.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

What is claimed is:

1. A method of automatically enriching a fuel-and-air supply from a carburetor to a combustion engine, comprising:
(a) cranking the engine;
(b) providing fuel from a fuel chamber to a fuel-and-air mixing passage through a primary fuel supply passage;
(c) sensing at least one of engine speed or engine temperature;
(d) comparing the at least one of the sensed engine speed or engine temperature to one or more respective reference values;
(e) closing a supplementary fuel supply passage in communication between the fuel chamber and the fuel-and-air mixing passage, when the at least one of the engine speed or engine temperature are greater than or equal to the one or more respective reference values;
(f) opening the supplementary fuel supply passage when at least one of the engine speed or engine temperature are less than their respective reference values to enrich the fuel-and-air supply to the engine;
(g) sensing whether the engine speed is greater than or equal to an engine running reference value;
(h) repeating steps (a) through (f) if the engine speed is less than the engine running reference value;
(i) repeating steps (b) through (f) if the engine speed is greater than or equal to the engine running reference value;
(j) powering a heater element during engine cranking;
(k) sensing temperature adjacent the heater element; and
(l) closing the supplementary fuel supply passage when the temperature adjacent the heater element exceeds a prescribed level, regardless of whether at least one of the engine speed or engine temperature are greater than or equal to their respective reference values.

2. A fuel enrichment system for a combustion engine, comprising:
a supplementary fuel supply passage provided between a carburetor fuel chamber and fuel-and-air mixing passage;
a solenoid valve for opening and closing the supplementary fuel supply passage;
at least one engine sensor including at least one of an engine speed sensor for detecting a rotational speed of the engine or an engine temperature sensor for detecting a temperature of the engine;
a switching device connected in series with the solenoid valve for controlling the solenoid valve; and
engine control circuitry, including:
a processor that turns the switching device on or off in dependence on at least one of a temperature detected by the engine temperature sensor or a speed detected by the engine speed sensor;
a resistive heater element connected in parallel across the solenoid valve and switching device; and
a thermistor placed adjacent the resistive heater element and connected to a control line of the switching device so as to draw current from the control line to turn off the switching device when the resistive heater element rises in temperature beyond a prescribed level.

3. The fuel enrichment system of claim 2, further comprising:
a power source for supplying power to the solenoid valve; and
another switching device arranged in series between the power source and the solenoid valve.

4. The fuel enrichment system of claim 3, wherein the power source is a battery and the another switching device is a relay.

5. The fuel enrichment system of claim 4, further comprising a recoil starter for manually cranking the engine.

6. The fuel enrichment system of claim 3, wherein the power source is a battery for supplying power to the solenoid valve and the other switching device is an engine start switch.

7. The fuel enrichment system of claim 6, further comprising an electric starter motor arranged between the engine start switch and the solenoid valve for automatically cranking the engine.

8. The fuel enrichment system of claim 2, further comprising an ignition switch in communication with the processor, and wherein the engine control circuitry further includes a relay for controlling power to the solenoid valve and a switching device connected in series with the relay and controlled by the processor for controlling the relay in response to activation of the ignition switch.

9. The fuel enrichment system of claim 2, wherein the engine control circuitry also includes ignition control circuitry.

10. The fuel enrichment system of claim 2, wherein the processor, a resistive heater element, and thermistor are integrated into a module.

11. The fuel enrichment system of claim 2, wherein the at least one engine sensor includes both an engine speed sensor for detecting a rotational speed of the engine and an engine temperature sensor for detecting a temperature of the engine, and the processor controls the switching device to open the solenoid valve when either the rotational speed of the engine is below a predetermined speed value or the temperature of the engine is below a predetermined temperature value, and to close the solenoid valve when either the rotational speed of the engine is above the predetermined speed value or the temperature of the engine is above the predetermined temperature value.

12. The fuel enrichment system of claim 2, further comprising:
an electric starter motor for automatically cranking the engine;
a power source for supplying power to the electric starter motor and the solenoid valve; and
at least one other switching device arranged in series between the power source and the electric starter motor.

13. The fuel enrichment system of claim 12, wherein the power source is a battery and the at least one other switching device is an engine start switch.

14. The fuel enrichment system of claim 12, wherein the power source is a battery and the at least one other switching device is a relay.

15. The fuel enrichment system of claim 2, further comprising:
an electric starter motor for automatically cranking the engine;
a power source for supplying power to the electric starter motor and the solenoid valve;
a capacitive discharge ignition device connected to the processor for powering the processor;
an ignition switch connected to ground and to the capacitive discharge ignition device for grounding the capacitive discharge ignition device when the ignition switch is turned off; and
an engine start switch arranged in series between the power source and the ignition switch.

16. The fuel enrichment system of claim 15, wherein the electric starter motor is arranged in series between the engine start switch and the ignition switch for grounding the electric starter motor when the ignition switch is turned on to enable current to flow through the motor when the engine start switch is activated.

17. The fuel enrichment system of claim 15, further comprising a relay having a coil arranged in series between the engine start switch and the ignition switch and having a contactor arranged in series between the power source and the electric starter motor, wherein the electric starter motor is grounded and current flows therethrough when the ignition switch is turned on and the engine start switch is closed.

18. A combustion engine, comprising:
an engine cranking device for cranking the engine, including at least one of a manual recoil starter or an electric starter motor;
a carburetor including:
a fuel chamber;
a fuel-and-air mixing passage;
a primary fuel supply passage between the fuel chamber and the fuel-and-air mixing passage; and
a supplementary fuel supply passage between the fuel chamber and the fuel-and-air mixing passage;
a solenoid valve for opening and closing the supplementary fuel supply passage;
at least one engine sensor including at least one of an engine speed sensor for detecting a rotational speed of the engine or an engine temperature sensor for detecting a temperature of the engine;
a switching device connected in series with the solenoid valve for controlling the valve; and
engine control circuitry, including:
a processor that turns the switching device on or off in dependence on at least one of a temperature detected by the temperature sensor or a speed detected by the engine speed sensor;
a resistive heater element connected in parallel across the solenoid valve and switching device; and
a thermistor placed adjacent the resistive heater element and connected to a control line of the switching device so as to draw current from the control line to turn off the switching device when the resistive heater element rises in temperature beyond a prescribed level.

19. The combustion engine of claim 18, further comprising an ignition switch in communication with the processor, and wherein the engine control circuitry further includes a relay connected to the battery for controlling power to the solenoid valve and a switching device connected in series with the relay and controlled by the processor for controlling the relay in response to activation of the ignition switch.

20. The combustion engine of claim 18, further comprising
a battery for supplying power to the solenoid valve; and
an engine start switch arranged in series between the battery and the solenoid valve
an electric starter motor arranged between the engine start switch and the solenoid valve for automatically cranking the engine.

21. The combustion engine of claim 18, further comprising:
an electric starter motor for automatically cranking the engine;
a power source for supplying power to the electric starter motor and the solenoid valve;
a capacitive discharge ignition device connected to the processor for powering the processor;
an ignition switch connected to ground and to the capacitive discharge ignition device for grounding the capacitive discharge ignition device when the ignition switch is turned off; and
an engine start switch arranged in series between the power source and the ignition switch.

22. A method of controlling supply of supplementary fuel through a supplementary fuel supply passage in a carburetor to an engine, comprising:
sensing engine cranking; and
preventing supply of supplementary fuel when the engine cranking reaches a prescribed number of revolutions.

23. The method of claim 22, wherein the sensing step includes powering a heater element during engine cranking, and sensing temperature adjacent the heater element.

24. The method of claim 23, wherein the preventing step includes closing a solenoid valve to close a supplementary fuel supply passage when heat produced by the resistive heater element reaches a prescribed temperature.

25. The method of claim 22, wherein the sensing step includes counting engine revolutions during cranking.

26. The method of claim 25, wherein the engine revolutions are counted using an engine rotation sensor and a counter.

27. The method of claim 26, wherein the preventing step includes preventing supply of the supplementary fuel when the counted engine revolutions reach a prescribed number of engine revolutions.

28. The method of claim 27, wherein the prescribed number of engine revolutions varies depending on engine temperature.

29. The method of claim 27, further comprising:
sensing engine temperature; and
preventing supply of the supplementary fuel when the sensed engine temperature reaches a prescribed amount.

30. The method of claim 29, wherein the prescribed number of engine revolutions varies depending on engine temperature.

31. The method of claim 22, further comprising:
sensing an engine condition;
comparing the sensed engine condition to a reference value;
opening the supplementary fuel supply passage when the sensed engine condition is less than the reference value; and
closing the supplementary fuel supply passage when the sensed engine condition is greater than or equal to the reference value.

32. The method of claim 22, wherein the preventing step is carried out using a control apparatus comprising:
an ignition circuit adapted to receive power and including an ignition switch;
a first switching device coupled to the solenoid valve and adapted to receive power for switched supply of power to the solenoid valve;
a second switching device coupled between the first switching device and ground;
a processor adapted to receive engine rotation signals and temperature signals, and coupled to the ignition switch of the ignition circuit to communicate an ignition signal thereto according to prescribed timing, and coupled to the first and second switches to communicate signals thereto to close the first switching device and open the second switching device to power the solenoid valve; and
a thermistor coupled between ground and a location between the processor and the second switch, wherein as resistance of the thermistor decreases, the signal from the processor to the second switching device is grounded through the thermistor to close the second switching device and ground the supply of power to the solenoid valve, thereby closing the solenoid valve.

33. The method of claim 32, further comprising a map module coupled to the processor and adapted to receive temperature signals.

34. The apparatus of claim 33, wherein the map module includes data including a prescribed quantity of engine revolutions in relation to temperature values.

35. A method of controlling a supply of supplementary fuel through a supplementary fuel supply passage in a carburetor to an engine, comprising:
sensing engine cranking using a rotation sensor to sense engine rotation, and a rotation counter to count engine revolutions; and
preventing supply of the supplementary fuel when the counted engine revolutions exceeds a prescribed number of engine revolutions.

36. The method of claim 35, wherein the prescribed number of engine revolutions varies depending on engine temperature.

37. The method of claim 35, further comprising:
sensing engine temperature; and
preventing supply of the supplementary fuel when the sensed engine temperature reaches a prescribed amount.

38. A method of controlling supply of supplementary fuel through a supplementary fuel supply passage in a carburetor to an engine, comprising:
sensing engine speed;
preventing supply of the supplementary fuel when the sensed engine speed is below a prescribed normal operating speed; and
permitting supply of the supplementary fuel when the sensed engine speed exceeds the prescribed normal operating speed.

39. The method of claim 38, wherein the steps of permitting and preventing are carried out using a solenoid valve.

40. The method of claim 39, further comprising the step of using a generator coil to power the solenoid valve.

41. The method of claim 38 wherein the permitting and preventing steps are carried out in synchronism with engine intake negative pressure.

42. A supplementary fuel supply system for a combustion engine, comprising:
a supplementary fuel supply passage provided between a carburetor fuel chamber and fuel-and-air mixing passage;
a solenoid valve for opening and closing the supplementary fuel supply passage;
at least one engine sensor indicative of engine cranking;
a switching device connected in series with the solenoid valve for controlling the solenoid valve; and
engine control circuitry, including a processor to turn control the switching device based on engine cranking detected by the at least one engine sensor.
